(19) United States
(12) Patent Application Publication
(10) Pub. No.: US 2018/0347993 A1
(43) Pub. Date: Dec. 6, 2018

(54) SYSTEMS AND METHODS FOR VERIFYING ROAD CURVATURE MAP DATA

(71) Applicant: GM GLOBAL TECHNOLOGY OPERATIONS LLC, Detroit, MI (US)

(72) Inventors: SARMAD Y. HERMIZ, TROY, MI (US); BING DENG, BLOOMFIELD HILLS, MI (US); ROBERT D. SAUVOLA, GRAND BLANC, MI (US); ABHISHEK SHUKLA, FARMINGTON, MI (US); RAYMOND G. ACKER, CLAWSON, MI (US)

(73) Assignee: GM GLOBAL TECHNOLOGY OPERATIONS LLC, Detroit, MI (US)

(21) Appl. No.: 15/610,276

(22) Filed: May 31, 2017

(51) Int. Cl. G01C 21/32; G05D 1/02

(52) U.S. Cl. CPC G01C 21/32; G05D 1/0212; G05D 1/0223; G05D 1/0274; G05D 1/027

(57) ABSTRACT

Systems and methods are provided for processing map data. The systems and methods calculate road curvature data for a curved road segment along a road based on measured data obtained from a measuring unit of a vehicle moving along the road. The systems and methods perform a map processing function on road map data for the road including the curved road segment based on the calculated road curvature data correlated with the global positioning data. The systems and methods include outputting result data resulting from the map processing function.

### TECHNICAL FIELD

The present disclosure generally relates to processing map data used by vehicles having automated control function such as automated vehicles, and more particularly relates to systems and methods for verifying road curvature data of an electronic map used in automated control of driving functions of a vehicle.

### BACKGROUND

Modern vehicle are capable of sensing the environment and executing control functions based on varying degrees of automation. Vehicles sense the environment using sensing devices such as radar, LIDAR, image sensors, and the like. Some vehicle systems further uses information from global positioning systems (GPS) technology, navigation systems, vehicle-to-vehicle communication, vehicle-to-infrastructure technology, and/or drive-by-wire systems to navigate the vehicle.

Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

Some vehicles having automated control functions (to varying degrees of automation) make use of high resolution digital maps that include embedded data describing attributes of roads such as road width, number of lanes, curb location, intersections, etc. The digital maps can be derived from road surveys performed by mapping cars having sensing units such as LIDAR scanners, radar devices, stereo cameras, etc. The obtained survey data is consolidated to derive road descriptors making up the digital map. The embedded map data is used in autonomous vehicle control, in some applications. Some digital maps embed road curvature data. The road curvature data is derived from road markings, in some implementations.

Accordingly, it is desirable to provide systems and methods that are able to generate and verify road curvature data for electronic road maps used by automatic vehicle control systems. It is further desirable to provide methods and systems for verifying electronic road maps for vehicles in a way that has relatively low hardware and processing requirements. Furthermore, other desirable features and characteristics of the present invention will become apparent from the subsequent detailed description and the appended claims, taken in conjunction with the accompanying drawings and the foregoing technical field and background.

### SUMMARY

Systems and methods are provided for processing map data. In one embodiment, a computer implemented method includes calculating road curvature data for a curved road segment along a road based on measured data obtained from a measuring unit of a vehicle moving along the road. The method includes performing a map processing function on road map data for the road including the curved road segment based on the calculated road curvature data correlated with the global positioning data. The method includes outputting result data resulting from the map processing function.

In various embodiments, the measured data includes acceleration data, the measuring unit includes an inertial measurement unit of the vehicle, and the road curvature data is calculated based on the acceleration data.

In various embodiments, the acceleration data is obtained from a yaw rate sensor of the inertial measurement unit.

In various embodiments, the measured data includes global positioning data obtained from the vehicle, and the step of calculating road curvature data is based on heading difference in the global position data at various points as the vehicle moves along the curved road segment.

In various embodiments, the method includes comparing calculated road curvature data and road curvature data obtained from the road map data. The map processing function is based on the comparison.

In various embodiments, the map processing function includes verifying road curvature data associated with the map data for the curved road segment by comparison with the calculated road curvature data for the curved road segment.

In various embodiments, the outputting result data includes outputting a verification result.

In various embodiments, the map data is derived from imaging data obtained by a LIDAR sensing unit, a radar unit and/or a stereo camera unit.

In various embodiments, the outputting step includes flagging a road, roads or a road segment for surveying by a mapping unit in response to the verification result. In various embodiments, the method includes storing new map data in the road map data based on data obtained by the mapping unit. The mapping unit may be a LIDAR sensing unit, a radar sensing unit and/or a stereo camera unit.

In various embodiments, the step of calculating road curvature data includes calculating road curvature data based on measured data obtained from measurement units of a crowd of vehicles.

In various embodiments, the method includes calculating first road curvature data for the curved road segment based on first measured data obtained from the measuring unit of the vehicle moving along the road and calculating second road curvature data for the curved road segment based on second, different, measured data obtained from the measuring unit of the vehicle moving along the road. The map processing function includes comparing road curvature data obtained from the map data, the first road curvature data and the second road curvature data, wherein the road curvature data from the map data, the first road curvature data and the second road curvature data are position coordinated in the comparison.

In another embodiment, a system for processing road map data is provided. The system includes a road curvature calculation module configured to calculate road curvature data for a curved road segment along a road based on measured data obtained from a measuring unit of a vehicle moving along the road, via a processor. The system includes a map processing module configured to perform a map processing function on road map data for the road including the curved road segment based on the calculated road curvature data correlated with global positioning data, via a processor. The system includes an output module configured to output result data resulting from the map processing function, via a processor.

In various embodiments, the measured data includes acceleration data and/or global position data and the road curvature data is calculated based on the acceleration data and/or heading difference in the global positioning data.

In various embodiments, the system includes a comparison module configured to compare global position coordinated road curvature data correlated with global positioning data obtained from the map data and the calculated road curvature data correlated with global position data.

In various embodiments, the system includes a comparison module configured to compare road curvature data obtained from the map data and calculated road curvature data and verifying the map data based on the comparison.

In various embodiments, the road curvature calculation module is configured to calculate first road curvature data for the curved road segment based on measured yaw rate data obtained from an inertial measurement unit of the vehicle and to calculate second road curvature data for the curved road segment based on heading difference of global position data obtained from a global positioning system, GPS, receiver of the vehicle, wherein the map processing module is configured to perform the map processing function on road map data based on the first and second calculated road curvature data.

In various embodiments, the map processing function includes verifying road curvature data associated with the map data for the curved road segment by comparison with the calculated road curvature data for the curved road segment.

In various embodiments, the map processing function includes flagging a road, road segment and/or roads for surveying by a mapping unit to when the calculated road curvature data does not sufficiently match the road curvature data stored in the road map data to obtain new road map data. The method may include storing the new road map data in the road map data.

In various embodiments, the system includes a map module configured to retrieve the map data from a data storage device of the vehicle and/or from a server via a network interface.

In various embodiments, the system includes an automated driving system configured to output automated driving controls based on road curvature data obtained from the map data.

In yet another embodiment, a vehicle is provided. The vehicle includes a measurement unit configured to measure data including global positioning data and/or acceleration data of a vehicle moving along a curved road segment of a road, via a processor. The vehicle includes a map database storing a map including road curvature data. The vehicle includes a vehicle control system configured to control acceleration, braking and/or steering of the vehicle based on map data. The system includes a processor configured to calculate road curvature data correlated with global position data based on the measured data, verify the road curvature data of the map based on the calculated road curvature data correlated with global positioning data, and output a verification result.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram illustrating a vehicle having a map verification system, in accordance with various embodiments;

FIG. 2 is a dataflow diagram illustrating a map verification system of the vehicle, in accordance with various embodiments;

FIG. 3 is a dataflow diagram illustrating a vehicle control system that uses verified maps, in accordance with various embodiments;

FIG. 4 is a flowchart illustrating a map verification method, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

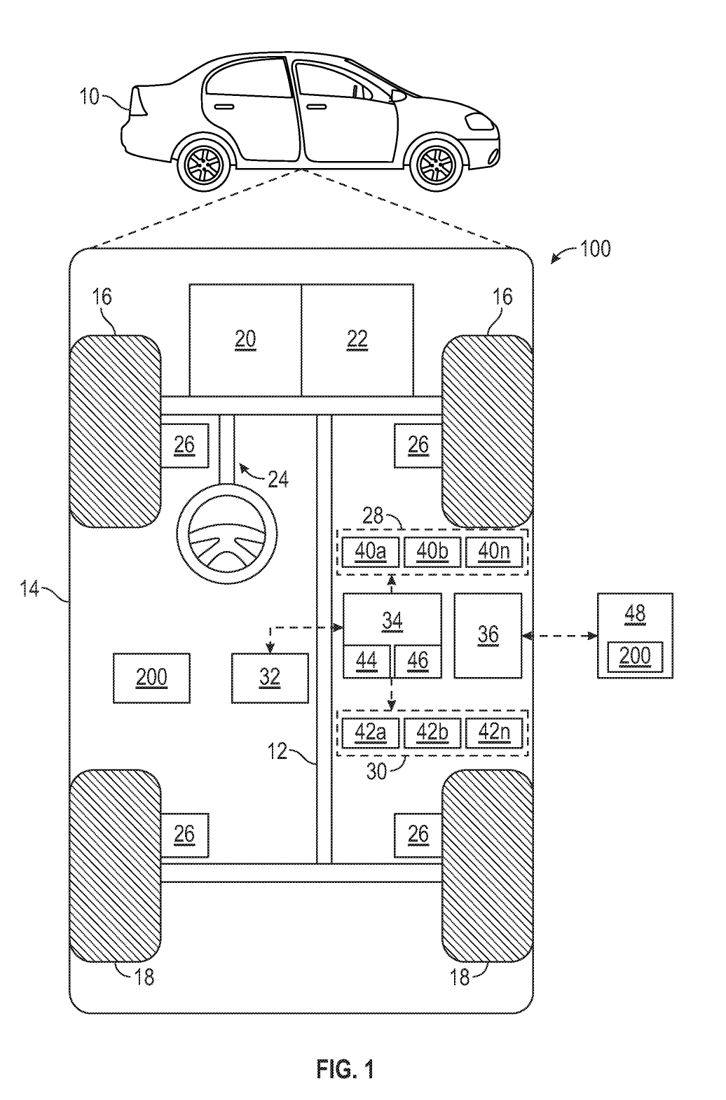

With reference to FIG. 1, a vehicle system shown generally at 100 is associated with a vehicle 10 in accordance with various embodiments. In general, the vehicle system 100 includes a map verification system 200 that verifies map data included in an electronic road map for use in controlling aspects of the vehicle system 100 such as automatic steering, braking and/or acceleration control aspects.

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the map verification system 200 is incorporated into the vehicle 10. It is envisaged, however, that some or all of the map verification system 200 is located remotely in alternative embodiments. The vehicle 10 is, for example, a vehicle that has automatic control capabilities including automatic steering, braking and/or acceleration features. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. In an exemplary embodiment, the vehicle 10 is an autonomous vehicle such as a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. However, the map verification systems and methods disclosed herein are applicable for use with a range of vehicle types, particularly those relying on machine to machine digital maps that describe road attributes for use in automated control of at least one function of the vehicle 10.

As shown, the vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16-18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16-18. The brake system 26 may, in various embodiments, include friction brakes, brake by wire, a regenerative braking system such as an electric machine, and/or other appropriate braking systems. The steering system 24 influences a position of the of the vehicle wheels 16-18. While depicted as including a steering wheel for illustrative purposes, in some embodiments contemplated within the scope of the present disclosure, the steering system 24 may not include a steering wheel.

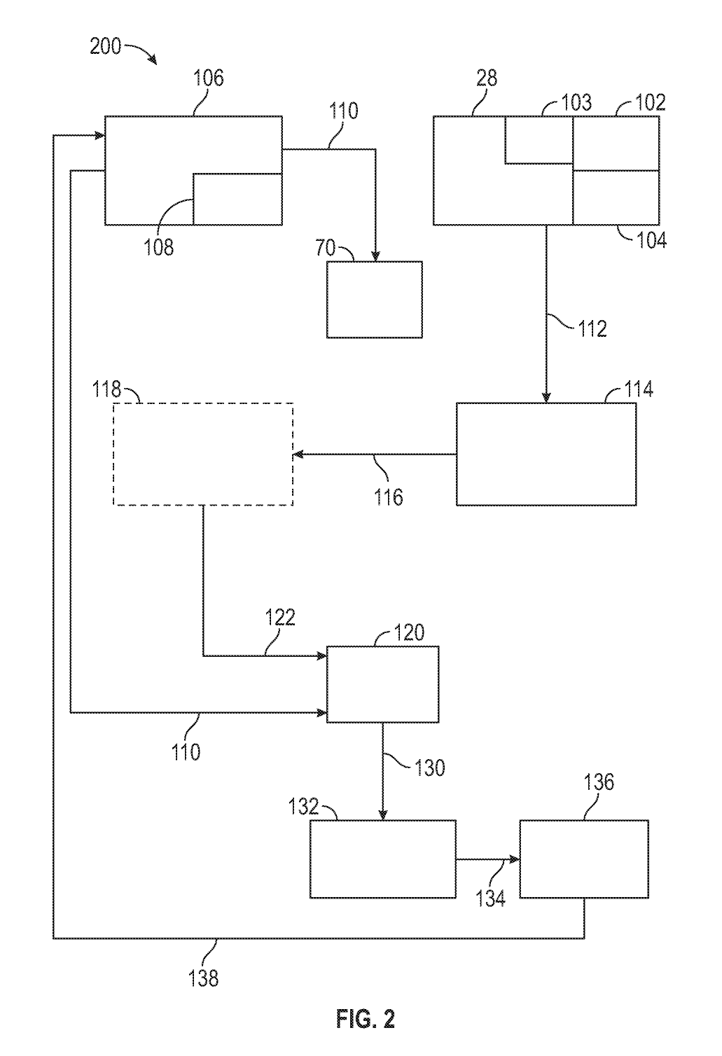

The sensor system 28 includes one or more sensing devices 40a-40n that sense observable conditions of the exterior environment and/or the interior environment of the vehicle 10. The sensing devices 40a-40n can include, but are not limited to, radars, LIDARs, speed sensors, acceleration sensors including yaw rate sensor, steering angle sensors, optical cameras, thermal cameras, ultrasonic sensors, and/or other sensors. As shown in FIG. 2, the sensor system 28 includes an inertial measurement unit 102 and a GPS receiver 104. The inertial measurement unit includes at least the yaw rate sensing device 40a-40n. The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

The data storage device 32 stores data for use in automatically controlling functions of the vehicle 10. In various embodiments, the data storage device 32 stores defined maps of the navigable environment. In various embodiments, the defined maps may be predefined by and obtained from a remote system. For example, the defined maps may be assembled by the remote system and communicated to the vehicle 10 (wirelessly and/or in a wired manner) and stored in the data storage device 32. In various embodiments, the defined maps are included in a map database 106. The defined maps include an electronic map 108 that includes driving parameters embedded therein including road curvature data. The electronic map 108 is derived from mapping vehicles that make use of road and road surrounding imaging device. For example, road scanning devices are used including range finding devices, like LIDAR and Radar, and/or stereo camera systems that are able to image roads and road surroundings in three dimensions. Autonomous driving critical parameters are derived from the high volume of data obtained by the mapping vehicles and stored along with precise global positioning data such as differential global positioning system, GPS, data. The electronic map 108 is a machine to machine map used in controlling vehicles, particularly autonomous vehicles, and includes at least road curvature data correlated with global positioning data. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

In various embodiments, one or more instructions of the controller 34 are embodied in the map verification system 200 and, when executed by the processor 44, calculate road curvature data based on measured data from the vehicle 10 and use the calculated road curvature data to verify road curvature data in the electronic map 108. For example, the instructions retrieve the verified electronic map 108 as described herein and execute automated control functions, particularly automatic driving control, of the vehicle 10 based on the retrieved electronic map 108.

The communication system 36 is configured to wirelessly communicate information to and from other entities 48, such as but not limited to, other vehicles (“V2V” communication,) infrastructure (“V2I” communication), remote systems, and/or personal devices. In various embodiments, the communication system 36 is configured to transmit map data to the map database 106. In exemplary embodiments where map verification system 200 is at least partly located remotely, map verification data is transmitted over a wireless network to the map database 108. For example, map verification results are transmitted to map database 106 for updating electronic map 108. In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

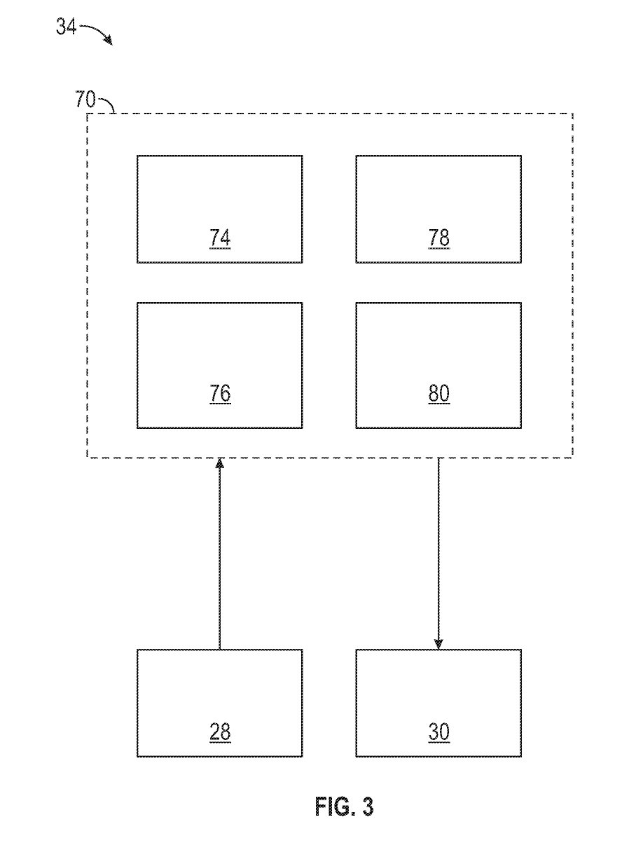

In accordance with various embodiments, controller 34 implements an automated vehicle control system 70 as shown in FIG. 3. In the present embodiment, the automated vehicle control system is described in terms of an autonomous driving system. However, this is to be taken as an example of a high-level implementation. It is envisaged that lesser levels of automation would make use of the map verification systems and methods of the present disclosure, particularly vehicles that make use of a machine map 108 for controlling at least one automatic vehicle driving function such as for automatic control of at least one of the propulsion system 20, the transmission system 22, the steering system 24, and the brake system 26. That is, suitable software and/or hardware components of controller 34 (e.g., processor 44 and computer-readable storage device 46) are utilized to provide a vehicle control system 70 that is used in conjunction with vehicle 10.

In various embodiments, the instructions of the vehicle control system 70 may be organized by function or system. For example, as shown in FIG. 3, the vehicle control system 70 can include a sensor fusion system 74, a positioning system 76, a guidance system 78, and a vehicle control system 80. As can be appreciated, in various embodiments, the instructions may be organized into any number of systems (e.g., combined, further partitioned, etc.) as the disclosure is not limited to the present examples.

In various embodiments, the sensor fusion system 74 synthesizes and processes sensor data and predicts the presence, location, classification, and/or path of objects and features of the environment of the vehicle 10. In various embodiments, the sensor fusion system 74 can incorporate information from multiple sensors, including but not limited to cameras, LIDARs, radars, and/or any number of other types of sensors.

The positioning system 76 processes sensor data along with other data to determine a position (e.g., a local position relative to a map, an exact position relative to lane of a road, vehicle heading, velocity, etc.) of the vehicle 10 relative to the environment. In various embodiments, the positioning system 76 uses the electronic map 108 that has been verified and updated through the map verification system 200 and methods described herein. The guidance system 78 processes sensor data along with other data to determine a path for the vehicle 10 to follow. The vehicle control system 80 generates control signals for controlling the vehicle 10 according to the determined path. In this way, the vehicle control system 80 generates control signals for controlling the vehicle 10 based at least party on the electronic map 108.

The control signals include a set of actuator commands to achieve the determined path, including, but not limited to, a steering command, a shift command, a throttle command, and a brake command. The control signals are communicated to the actuator system 30. In an exemplary embodiment, the actuators 42 include a steering control, a shifter control, a throttle control, and a brake control. The steering control may, for example, control a steering system 24 as illustrated in FIG. 1. The shifter control may, for example, control a transmission system 22 as illustrated in FIG. 1. The throttle control may, for example, control a propulsion system 20 as illustrated in FIG. 1. The brake control may, for example, control wheel brake system 26 as illustrated in FIG. 1.

In various embodiments, the controller 34 implements machine learning techniques to assist the functionality of the controller 34, such as feature detection/classification, obstruction mitigation, route traversal, mapping, sensor integration, ground-truth determination, and the like.

Referring now to FIG. 2, and with continued reference to FIGS. 1 and 3, a dataflow diagram illustrates various embodiments of the map verification system 200 which may be embedded within the controller 34. Various embodiments of the map verification system 200 according to the present disclosure can include any number of sub-modules embedded within the controller 34. As can be appreciated, the sub-modules shown in FIG. 2 can be combined and/or further partitioned to similarly perform steps of verifying parameters embedded in road map data 110 based on calculated parameters corresponding to the parameters stored in the map data based on measurement of vehicle motion taken by the sensor system 28, particularly by an inertial measurement unit 102.

In various embodiments, map verification system 200 includes map database 106 storing the electronic map 108. In embodiments, map database 106 including electronic map 108 is stored in vehicle storage device 32, on a remote server 48 and accessible through communications system 36 or distributed therebetween. It is envisaged that map database 106 including electronic map 108 is updated regularly or irregularly from remote server 48 including by incorporation of new map data 138 as described further below. Electronic map 108 includes road curvature or road trajectory data in embodiments. In other embodiments, electronic map 108 includes data from which road curvature or road trajectory is derived.

In various embodiments, map verification system 200 includes sensor system 28 providing sensed data 112 from a variety of vehicle sensors such as an inertial measurement unit 102, global positioning system, GPS, receiver 104, speed sensor 103 and steering wheel angle sensor. In embodiments, inertial measurement unit 102 detects current rate of acceleration using one or more accelerometers, and detects changes in rotational attributes like pitch, roll and yaw using one or more gyroscopes. One exemplary inertial measurement unit 102 includes a fiber optic gyroscope for measuring rotational acceleration including yaw rate. Such a gyroscope is a relatively low noise device. GPS receiver 104 is a standard GPS receiver in some embodiments and a differential global positioning system (DGPS) receiver in other embodiments. DGPS is an enhancement to GPS that provides improved location accuracy, from the 15-meter nominal GPS accuracy to as highly resolved as about 10 cm. The speed sensor 103 is based on wheel encoder counting, in some embodiments.

Sensed data 112 is provided from sensor system 28 to data receiving module 114. Data receiving module 114 is included in sensor fusion system 74, in embodiments. Data receiving module 114 is configured to pre-process sensor data 114 and route pre-processed sensor data 116 to other modules for further processing.

In various embodiments, map verification system 200 includes road curvature calculation module 118 configured to receive sensed data 116 and to calculate road curvature data 122. Road curvature calculation module 118 is configured to calculate road curvature data 122 for roads being traversed by the vehicle 10 based on motion parameters sensed by on-board sensors of the vehicle's sensor system 28. In particular, road curvature data 122 is calculated based on acceleration data, global positioning data (e.g. GPS or DGPS) heading difference, steering angle and speed or other motion based parameters that are sensed by sensor system 28 located on board vehicle 10. Calculated road curvature data 122 is correlated with global position data based on data obtained from GPS receiver 104. Other sampling rates are possible for calculating road curvature data 122 such as every five meters of travel or less or every second or less. Road curvature data 122 is calculated at frequent intervals such as at every global positioning measuring point by the GPS receiver 104. A variety of road curvature calculations are feasible. Exemplary road curvature calculations are described below:

RadiusOfCurvature=VehSpeed/(dYawRate*π/180) (1)

where RadiusOfCurvature is calculated in meters. VehSpeed is obtained from sensed values of speed obtained from speed sensor 103 of sensor system 28 and is used in meters per second. dYawRate is time rate of change in yaw rate obtained from sensed values of yaw rate from inertial measurement unit 104 of sensor system 28 and is used in degrees per second. Taking the reciprocal of RadiusOfCurvature allows road curvature to be determined.

Calculated road curvature data 122 is additional or alternatively calculated based on global positioning data from the GPS receiver 104 and change in heading difference. Such a scheme utilizes successive snap-shots of global positioning data from GPS receiver 104 for the vehicle 10 and global position heading as the vehicle 10 is moving. Road curvature calculation module 118 obtains a first vehicle location, a second vehicle location, and a third location in terms of global position coordinates. Road curvature calculation module 118 obtains first heading from the first vehicle location to the second vehicle location, and second heading from the second location to the third in terms of degrees relative to North. Road curvature calculation module 118 calculates distance moved (difference in position) from the second vehicle location to the third vehicle location. Road curvature calculation module 118 calculates heading difference in degrees from the first and second vehicle locations based on heading difference between the first and second headings. Road curvature calculation module 118 divides distance moved in meters by heading difference in degrees to calculate distance moved per degree of heading change that occurred as the vehicle moved from the second vehicle location to the third vehicle location. Road curvature calculation module 118 multiplies the distance moved per degree by 360 to obtain circumference of circular driving distance that will cause 360 degrees of heading change, which is the distance that the vehicle 10 must travel to complete a circular path.

Road curvature calculation module 118 is able to obtain radius of road curvature based on the well known relationship

RadiusOfCurvature=Circumference/2π (2)

Road curvature calculation module 118 takes the reciprocal of RadiusOfCurvature to determine road curvature between the second and third vehicle locations.

In another additional or alternative embodiment, road curvature is derived from a relationship between road curvature, vehicle speed as sensed by speed sensor 103 and front and rear steering angles as determinable from a steering column sensor or other steering angle sensor forming part of the sensor system 28.

In various embodiments, the map verification system 200 includes a comparison module configured to receive road map data 110 from the electronic map 108. The road map data 110 includes road curvature or road trajectory data embedded therein, and other parameters associated with roads, correlated with global positioning data. Road curvature data extracted from road map data 110, which is correlated with global positioning data such as GPS or DGPS locations, is compared by comparison module 120 with calculated road curvature data 122, which is correlated with global positioning data, as calculated by road curvature calculation module 118. That is, location corresponding road curvature data from the road map data 110 and from the road curvature calculation module 118 is compared by the comparison module 120. Any suitable comparison technique can be used that assesses a degree of concordance of the two sets of road curvature data. For example, a convolution function could be used. Alternatively, the comparison involves assessing that curves constructed from the road curvature data sets have positive and negative gradients at substantially the same locations. In another possibility, a point by point comparison is performed comprising determining an absolute value difference in road curvature data for each location corresponding point of the calculated road curvature data 122 and the road map data 110 and running a summation of the difference for each point. In another embodiment, a combination of comparison techniques is used.

In embodiments, comparison module 120 location synchronizes calculated road curvature data 122 and road curvature data derived from road map data 110 based on global position data correlated with each form of road curvature data. Comparison module 120 compares the location synchronized data to determine an indication of degree of concordance of the data for subsequent output as result data 130.

In various embodiments, different road curvature calculation techniques are used by road curvature calculation module 118 based on different sensed data 112 to output different calculated road curvature data 118. For example, first and second streams of calculated road curvature data 122 is output by road curvature calculation module 118. In one example, the first stream of calculated road curvature data 122 is calculated based on equation (1) above, i.e. is based on speed and acceleration sensed data 112. In another example, the second stream of road curvature data 122 is calculated based on heading difference as described above. Comparison module 120 is configured to compare the first and second streams of calculated road curvature data 122, or a fusion thereof, with road curvature data extracted from road map data 110. In one embodiment, comparison module 120 is configured to location synchronize the first and second streams of calculated road curvature data 122 with road curvature data extracted from road map data 110. Alternatively, a fusion, e.g. average, of the first and second streams of calculated road curvature data 122 is created by comparison module 120 for comparison with road curvature data extracted from road map data 110. In any event, result data 130 is, in some embodiments, determined based on more than one different stream of calculated road curvature data 122.

Road curvature calculation module 118 is illustrated with a dashed box to indicate that this module is optional in some embodiments. In such embodiments, comparison module compares sensed data indicating road curvature based on sensed data 112 with data indicative of road curvature data from road map data 110 rather than first converting such data first into road curvature data 122 through road curvature calculation module 118. For example, yaw rate and/or heading difference is location synchronized by comparison module 120 with curvature indicating road map data 110 for purposes of comparison. Such a comparison relies more on a comparison of general form of curves constructed from respective data (e.g. gradient increasing and decreasing at same locations, start and end of road curves at same locations, etc.) rather a comparison of absolute values.

In some embodiments, road curvature calculation module 118 is configured to determine curve transitions, e.g. transitions from straight to curved segments, based on calculated road curvature data 122 or road curvature data extracted from road map data 110 and to perform comparison techniques described herein only at, or concentrated at, curve transitions.

In some embodiments, road curvature calculation module 118 is configured to calculate road curvature data based on road map data 110. In such embodiments, electronic map 108 does not include road curvature data values directly, but such values are determinable from road map data 110 through road curvature calculation module 118. For example, road map data 110 includes location data describing road trajectory from which road curvature calculation module 118 is able to generate road curvature values, e.g. using the heading difference technique described herein. Comparison module 120 would then operate to compare calculated road curvature data 122 based on sensed data 112 and calculated road curvature data 122 based on road map data 110.

In various embodiments, comparison module 130 outputs result data 130, which is a quantitative or qualitive assessment of the comparison between calculated road curvature data 122 and road curvature data extracted from the road map data 110. The result data 130 is provided to map verification module 132, which evaluates result data 134 to verify accuracy of road curvature data 110 in electronic map 108. In embodiments, map verification module 132 determines whether result data 130 from comparison module, in quantitative form, breaches a predetermined or dynamic threshold representing a maximum departure in road curvature data from the map data 110 and calculated road curvature data 122. Should the threshold be breached, a flag or flags 134 is/are set against the location/s in the road map data 110 that require re-surveying by a mapping unit 136 to re-determine road curvature data 110 for the flagged location/s. Flag 134 is in some embodiments, a marking in road map data and is in some embodiments an output command for re-surveying.

For locations in road map data 110 determined to have road curvature data in concordance with calculated road curvature data 122, further map processing, i.e. re-survey at that location, is not necessary. The map verification module 132 is, in some embodiments but not necessarily, configured to mark such locations in the road map data 110 with a positive verification result. Locations where the calculated road curvature data 122 and map road curvature data are not sufficiently in concordance are marked or flagged with a negative verification result by the map verifications system 132.

In embodiments, map verification system 200 includes a mapping unit 136. The mapping unit 136 includes a mapping vehicle in some embodiments. The mapping vehicle 136 includes at least one of a LIDAR unit, a radar unit and a stereoscopic camera unit along with a GPS receiver, usually a DGPS receiver, for obtaining three-dimensional images of roads and road surroundings in a detailed survey thereof. Mapping unit 136 is responsive to flag 134 against a location or locations indicating a lack of sufficient concordance between map road curvature data and calculated road curvature data 122. By re-surveying the road or road segment found to have deficient road map data, new road map data 138 is able to be derived by the mapping unit 136 based on the new survey data from the mapping vehicle. New road map data 138 includes updated or corrected road curvature data. New road map data 138 is stored in electronic map 108 for use by vehicle control system 70 in automatic control of at least one vehicle function based thereon, particularly based on new road curvature data included in the new road map data 138.

Map verification system 200 has been described in the context of a single vehicle 10 obtaining sensed data 112. In alternative embodiments, a crowd of vehicles obtain sensed data 112 allowing enhanced accuracy of calculated road curvature data 122 through greater population of data for corresponding locations.

In embodiments, at least one of road curvature calculation module 118, comparison module 120 and map verification module 132 is located remotely from vehicle 10. That is, in one exemplary implementation, calculation of road curvature data 122, comparison with map road curvature data and verification of concordance of road curvature data is performed locally at vehicle 10 or by a remote server 48. In other exemplary implementations, vehicle 10 is configured to transmit sensed data 112 to remote server 48 through communications system 36 and to receive new map data 138 from remote server 48 through communications system 36, with road curvature calculation module 118, comparison module 120 and map verification system 132 being remotely located. In some examples, the vehicle 10 is configured to perform real-time road curvature calculations, comparison and map verifications as sensed data 112 is received. In other examples, a journey log is taken and the road curvature calculations, comparison and map verifications are performed in a batch operation, possibly through remote server 48.

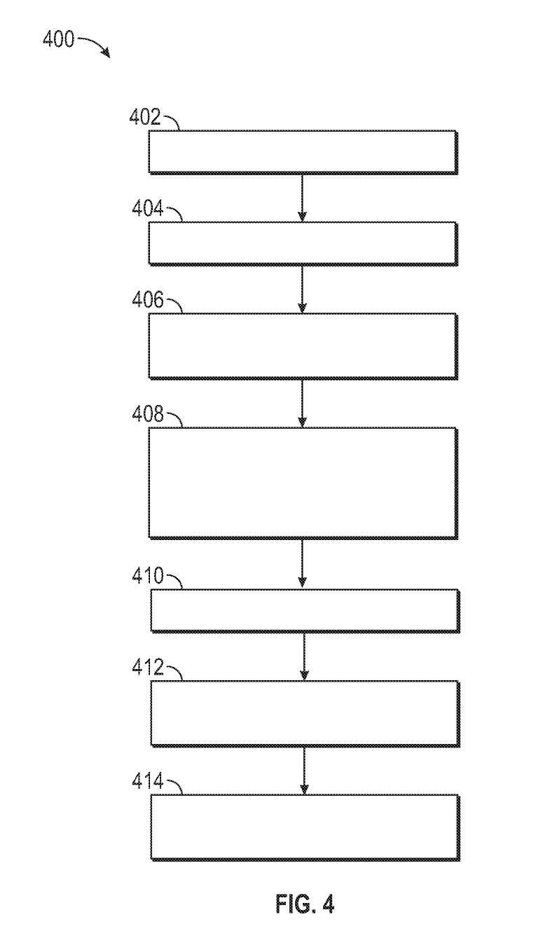

Referring now to FIG. 4, and with continued reference to FIGS. 1-3, a flowchart illustrates a method 400 that can be performed by the map verification system 200 of FIG. 3 in accordance with the present disclosure. As can be appreciated in light of the disclosure, the order of operation within the method is not limited to the sequential execution as illustrated in FIG. 4, but may be performed in one or more varying orders as applicable and in accordance with the present disclosure. In various embodiments, the method 400 can be scheduled to run based on one or more predetermined events, and/or can run continuously during operation of the vehicle 10.

In various embodiments, method 400 begins at step 402 by receiving sensed data 112. Sensed data 112 is received from sensor system 28. Sensed data 112 includes parameters representing aspects of vehicle motion including acceleration, particularly yaw rate, from inertial measurement unit 102 and speed from speed sensor 103 as well as parameters sampled during vehicle motion including global position data from GPS receiver 104 (including a DGPS implementation) and optionally steering wheel angle from an appropriate sensor.

Method 400 includes a step 404 of receiving road map data 110 from electronic map 108. Road map data 110 includes road curvature data embedded in the road map data 110 referred to as map road curvature data. The electronic map 108 is a machine map used by vehicle control system to control at least one automated function including automated control of, or aspects of, the propulsion system 20, the transmission system 22, the steering system 24, and the brake system 26.

Method 400 includes a step 406 of calculating road curvature data 122 based on sensed data 112 from sensor system 28 of vehicle 10. Calculated road curvature data 122 is calculated from parameters sensed by sensor system 28 as vehicle 10 traverses a road, particularly a curved segment thereof. In exemplary implementations, road curvature data 122 is calculated using equations (1) and/or (2) described above or other techniques either described herein or otherwise. In some embodiments, step 406 includes calculating road curvature data 122 based on more than one different technique and based on different input parameters from sensed data 112 for each technique, thereby creating more than one stream of calculated road curvature data 122.

Method 400 includes a step 408 of comparing road curvature data based on road map data 110 and road curvature data based on sensed data 112. Generally, step 408 includes comparing map road curvature data and calculated road curvature data 122. In an alternative embodiment, a parameter indicative of road curvature data from the sensed data 112, such as yaw rate and/or heading difference, is compared with map road curvature data in a location correlated way. Although different units are being compared in such an alternative embodiment (e.g. road curvature, heading difference and yaw rate), a general concordance of data is still determinable based on start and end of bends ascertainable from curves representing the data sets, for example. In this alternative embodiment, calculating step 408 is not necessary, which is why it shown in a dashed box. For more accurate comparison of degree of conformity of map road curvature data and road curvature data derived from sensed data 112, a comparison of calculated road curvature data 122 and map road curvature data is performed in step 408. In embodiments, comparison step 408 uses any available comparison technique for assessing concordance of two data sets such as a convolution, as described further with reference to comparison module 120. In embodiments, map road curvature data and more than one stream of calculated road curvature data are compared in step 408.

Method 400 includes step 410 of verifying road map data 110. Comparison step 408 returns an assessment on degree of concordance of map road curvature data and calculated road curvature data 122. Verifying step 410 positively or negatively verifies road map data 110 based on whether the degree of concordance from comparison step 408 is sufficiently close. If map road curvature data and calculated road curvature data 122 are not determined to be sufficiently in conformity, verifying step 410 returns negative concordance flag 134.

Method 400 includes a step 412, which is optional as shown by dashed box, of utilizing road map data 110 that has been verified in step 410 in vehicle control system 70 for at least one automated function including automated control of, or aspects of, the propulsion system 20, the transmission system 22, the steering system 24, and the brake system 26.

Method 400 includes a step 414 of flagging roads or road segments in response to negative concordance result from verifying step 410. Flag 134 is a marking in road map data 134 or a command output to mapping unit 136 or to a queue for mapping unit resources.

In embodiments, method 400 includes further steps (not shown). Mapping unit 136 is responsive to flag 134 to perform a new survey corresponding to at least one road location associated with the flag 134. The new survey is performed using a mapping vehicle from which new road map data 138 is derived including corrected road curvature data. New road map data 138 is stored in electronic map 108 and is used by vehicle control system 70.

The systems and method of the present disclosure allow electronic map 108 to be verified for accuracy as regards road curvature data based on parameters sensed by at least one vehicle 10 when moving along roads. In the event of a negative determination on accuracy of road curvature data in the electronic map 108 for certain locations, a new survey of the locations is performed by a mapping vehicle to allow for corrections to be included in road curvature data of the electronic map 108. In this way, electronic map 108 is kept accurate and surveying efficiency is assured. Further, vehicle control system 70 operates on the basis of accurate map data for effective operation.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A computer implemented method of processing road map data, comprising:
calculating road curvature data for at least one curved road segment along a road based on measured data obtained from at least one measuring unit of a vehicle moving along the road;
performing a map processing function on road map data for the road including the at least one curved road segment based on the measured road curvature data correlated with the global positioning data;
outputting result data resulting from the map processing function.

2. The computer implemented method of claim 1, wherein the measured data comprises acceleration data, the at least one measuring unit comprises an inertial measurement unit of the vehicle, and the road curvature data is calculated based on the acceleration data.

3. The computer implemented method of claim 2, wherein the acceleration data is obtained from a yaw rate sensor of the inertial measurement unit.

4. The computer implement method of claim 1, wherein the measured data comprises global positioning data obtained from the vehicle, and the step of calculating road curvature data is based on heading difference in the global position data at various points as the vehicle moves along the at least one curved road segment.

5. The computer implemented method of claim 1, wherein the map processing function comprises verifying road curvature data associated with the road map data for the at least one curved road segment by comparison with the calculated road curvature data for the at least one curved road segment.

6. The computer implemented method of claim 5, wherein the step of outputting result data comprises outputting a verification result.

7. The computer implemented method of claim 6, comprising flagging a road, roads or a road segment for surveying by a mapping unit in response to the verification result.

8. The computer implemented method of claim 7, comprising storing new road map data in the road map data based on data obtained by the mapping unit.

9. The computer implemented method of claim 1, wherein the road map data is derived from a survey performed by at least one of a LIDAR sensing unit, a radar sensing unit and a stereo camera unit.

10. The computer implemented method of claim 1, wherein the step of calculating road curvature data comprises calculating road curvature data based on measured data obtained from measurement units of a crowd of vehicles.

11. The computer implemented method of claim 1, comprising calculating first road curvature data for the at least one curved road segment based on first measured data obtained from the at least one measuring unit of the vehicle moving along the road and calculating second road curvature data for the at least one curved road segment based on second, different, measured data obtained from the at least one measuring unit of the vehicle moving along the road, wherein the map processing function comprises comparing road curvature data obtained from the road map data, the first road curvature data and the second road curvature data, wherein the road curvature data from the road map data the first road curvature data and the second road curvature data are position coordinated in the comparison.

12. A system for processing road map data, the system comprising:
a road curvature calculation module configured to calculate road curvature data for at least one curved road segment along a road based on measured data obtained from at least one measuring unit of a vehicle moving along the road, via at least one processor;
a map processing module configured to perform a map processing function on road map data for the road including the at least one curved road segment based on the calculated road curvature data correlated with global positioning data, via at least one processor; and
an output module configured to output result data resulting from the map processing function, via at least one processor.

13. The system of claim 12, wherein the measured data comprises at least one of acceleration data and global position data and the road curvature data is calculated based on at least one of the acceleration data and heading difference in the global positioning data.

14. The system of claim 12, wherein the map processing function comprises comparing global position coordinated road curvature data correlated with global positioning data obtained from the road map data and the calculated road curvature data correlated with global position data.

15. The system of claim 12, wherein the road curvature calculation module is configured to calculate first road curvature data for the at least one curved road segment based on measured yaw rate data obtained from an inertial measurement unit of the vehicle and to calculate second road curvature data for the at least one curved road segment based on heading difference of global position data obtained from a global positioning system, GPS, receiver of the vehicle, wherein the map processing module is configured to perform the map processing function on road map data based on the first and second calculated road curvature data.

16. The system of claim 12, wherein the map processing function comprises verifying road curvature data associated with the road map data for the at least one curved road segment by comparison with the calculated road curvature data for the at least one curved road segment.

17. The system of claim 16, wherein the map processing function comprises flagging a road, road segment or roads for surveying by a mapping unit in response to the verifying and storing new road map data in the road map data based on road map data obtained by surveying with the mapping unit.

18. The system of claim 12, comprising a map module configured to retrieve the road map data from at least one of a data storage device of the vehicle and from a remote server via a network interface.

19. The system of claim 12 comprising an automated vehicle control system configured to output automated driving controls based on road curvature data obtained from the road map data.

20. A vehicle, comprising:
at least one measurement unit configured to measure data including at least one of global positioning data and acceleration data of a vehicle moving along at least one curved road segment of a road, via at least one processor;
a map database storing at least one map including road curvature data;
a vehicle control system configured to control at least one of acceleration, braking and steering of the vehicle based on road map data of the at least one map at least one processor configured to:
calculate road curvature data correlated with global position data based on the measured data;
verify the road curvature data of the at least one map based on the calculated road curvature data correlated with global positioning data; and
output a verification result.
